(19) United States
(12) Patent Application Publication
(10) Pub. No.: US 2024/0326265 A1
(43) Pub. Date: Oct. 3, 2024

(54) Visual Grabber Pick-Up Tool Assembly

(71) Applicant: Michael Hong, Taylors, SC (US)

(72) Inventor: Michael Hong, Taylors, SC (US)

(21) Appl. No.: 18/356,823

(22) Filed: Jul. 21, 2023

(30) Foreign Application Priority Data
Apr. 3, 2023 (CN) CN2023206955769

(51) Int. Cl. B25J 18/02; B25J 1/04

(52) U.S. Cl. CPC B25J 18/025; B25J 1/04

(57) ABSTRACT

A visual grabber device includes a successively connected restraint tube, spring tube, and buffer tube, a visual pick-up unit and a driving unit. The visual grabbing unit includes a grabber body and a camera tube for viewing the target object. The camera tube is equipped with a camera and light. The grabber body comprises several pick-up grabbing claws, and the side wall of the camera tube includes a claw groove for each grabbing claw. The driving unit includes a flexible or rigid push-pull rod. One end of the grabber body is connected to the front end of the push-pull rod, and the rear end of the push-pull rod is connected to a rear connector and a center tube. The end of the center tube is connected to a pressing box, which includes a circuit board, and the camera is electrically connected to the circuit board.

### CROSS REFERENCE TO RELATED APPLICATIONS

The present application claims priority to Chinese Patent Application No. 2023206955769 filed Apr. 3, 2023, which is hereby incorporated herein, in its entirety.

### FIELD OF THE INVENTION

The present invention relates to the technical field of grabbing devices, and more specifically to a visual grabber pick-up tool.

### BACKGROUND OF THE INVENTION

Foreign object retrievers are widely used tools for people to search for and retrieve lost or fallen items from narrow gaps and inside deep holes, serving as a powerful assistant in daily life and disaster rescue situation.

Existing grabbers generally consist of a tubular part and grabbing claws. When the grabber claws are inside the tubular part, they are in a closed state, and when they extend out, they are in an open state, thus achieving a technical effect of grabbing objects. Similar patents, such as the “Foreign Object Retriever for Human Body Cavities” disclosed in CN112754602A, have a structure similar to existing grabbers but with slightly different application scopes.

Additionally, US Patent Application Publication No. 2020/0383557 discloses an endoscopic grabber apparatus including a proximal housing, a distal assembly, a flexible shaft extending between the proximal housing and the distal assembly, a flexible member within the flexible shaft having a distal end portion connected to the distal assembly and a proximal end portion connected to the proximal housing, and a camera within the distal assembly. A distal end portion of the flexible member is movably disposed within the distal assembly. A proximal end portion of the flexible member is connected to an actuator within the proximal housing. Actuation of the proximal end portion moves the distal end portion of the flexible member such that a protrusion extending from the distal end portion deforms to form part of a grabber. The camera is configured to capture an image including a tip portion of the protrusion. The endoscopic grabber device can include multiple protrusions configured to grab a target object.

The references cited above are hereby incorporated herein by reference, in their entireties.

However, when existing grabbers face depths and locations that are difficult to reach by the naked eye, the operator sometimes struggles to complete tasks due to their inability to visually detect and accurately align with the target objects with the grabber claws. Existing endoscopes with a working channel can accomplish this job, but endoscopes with both grabbing and visual observation functions have complex structures, high costs, and are difficult to use in many everyday application scenarios such as households. Current visual grabbers equipped with a small camera have small monitor and more expensive.

Therefore, there is an urgent need for a visual grabber in the market to address the aforementioned issues.

### SUMMARY OF THE INVENTION

One purpose of the present invention is to provide a visual grabber to solve the technical problems existing in the prior art. The visual grabbing unit is equipped with a camera, which can help to clearly see the surrounding environment and facilitate the grabbing of target objects. The overall structure is simple, the manufacturing process is straightforward, and the device is easy to use.

To achieve the above purpose, this invention provides the following device: This invention discloses a visual grabber, which includes sequentially connected restraint tube, spring tube, and buffer tube, a visual grabbing unit and a driving unit.

The visual grabbing unit includes a grabbing claw body and a camera tube. The camera is installed in the camera tube, and the grabbing claw body includes several grabbing claws. Several claw grooves are provided on the outside wall of the camera tube, and each grabbing claw can slide in a claw groove to connect.

The driving unit includes flexible, bendable or rigid push-pull rods. The end of the grabbing claw body far away from the camera tube is connected to the front end of the flexible push-pull rod through a front connecting piece. One end of the camera tube is fixed on the front connecting piece. The rear end of the flexible push-pull rod is connected to a rear connecting piece and a central tube. The flexible push-pull rod passes through the restraint tube, the spring tube, the buffer tube, the rear connecting piece, and the central tube. Both the rear connecting piece and the central tube slide into the buffer tube. The end of the central tube away from the buffer tube is connected with a pressing box, which serves to actuate the push-pull rod between an extended position and a retracted position. There is a circuit board inside the pressing box. The camera is electrically connected to the circuit board through wires.

Preferably, wire grooves are provided on the camera tube, and the connecting wires of the camera can pass through the wire grooves. The rear connecting piece is preferably a cylindrical structure, and has a first channel and a second channel on the rear connection piece. In one embodiment, one end of the flexible push-pull rod is fixed in the first channel, and the connecting wires of the camera are electrically connected to the circuit board passing through the second channel. In a preferred embodiment, a reset spring is provided inside the buffer tube. One end of the reset spring can abut the rear connecting piece, and the other end can abut one end of the spring tube.

Preferably, a USB interface is provided on the pressing box for the camera, and LED lights are provided at the front end of the camera. Further, in a preferred embodiment, one or more magnets may provided at or adjacent the end of the restraint tube away from the spring tube, and is used to facilitate the retrieval of a magnetic or metallic target object that is subject to magnetic forces.

The present invention has achieved the following technical success compared with the prior art:

In this device, a camera is preferably installed in the camera tube, allowing the end users to view in real-time the position of the target object and the surrounding environment through the images captured and transmitted by the camera to a video screen when operating the visual grabber, thus achieving accurate grab.

### DESCRIPTION OF THE DRAWINGS

In order to more clearly illustrate the technical solutions of the embodiments of the present invention, a brief introduction to the accompanying drawings required in the embodiments will be provided below. It is clear that the accompanying drawings described below are only some embodiments of the present device, and for those skilled in the art, other accompanying drawings can be obtained based on these drawings easily.

These and other features, aspects, and advantages of the present invention will become better understood with regard to the following description and accompanying drawings where:

FIG. 1 is an external view of the visual grabber in the embodiment of the present invented device;

FIG. 2 is an internal cross-sectional view of the visual grabber in the embodiment of the present invention;

FIG. 3 is a schematic diagram of the claw body opening in the visual grabber in the embodiment of the present invention;

FIG. 4 is a schematic diagram of the claw body closing in the visual grabber in the embodiment of the present invention; and

FIG. 5 is a structural schematic diagram of the camera tube in the visual grabber in the embodiment of the present invention.

### DETAILED DESCRIPTION OF THE INVENTION

The following is a clear and complete description of the technical solutions in the embodiments of this invention, in conjunction with the drawings in the embodiments of this invented device. It should be noted that the described embodiments are only a part of the embodiments of this invention, but not all of them. Based on the embodiments of this invention, all other embodiments obtained by those skilled in the art without creative work are covered to the scope of this invention.

The purpose of this invention is to provide a visual grabber to solve the technical problems existing in the prior art. A camera is installed at the front end of the visual grabbing unit, which can clearly see the environment around the claws and the target object, facilitating accurate and efficient grabbing, and the overall structure is relatively simple, and the manufacturing process is easy.

To make the purpose, features, and advantages of this invention more apparent and easier to understand, the following is a further detailed description of the invention in conjunction with the drawings and specific embodiments.

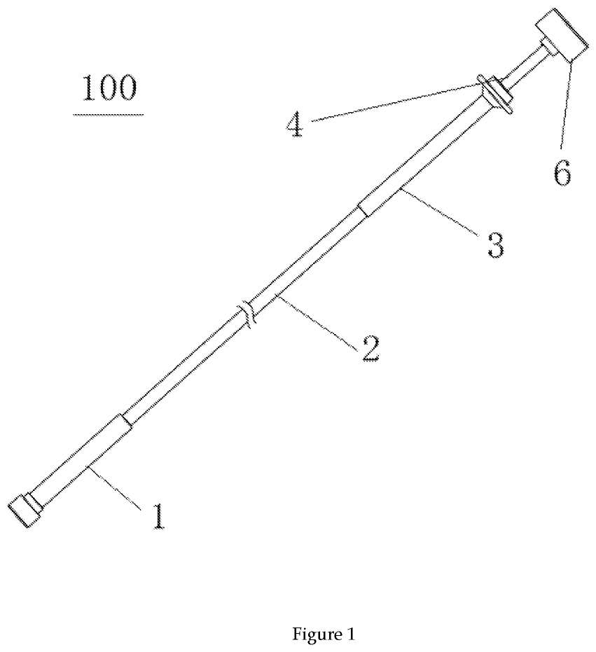

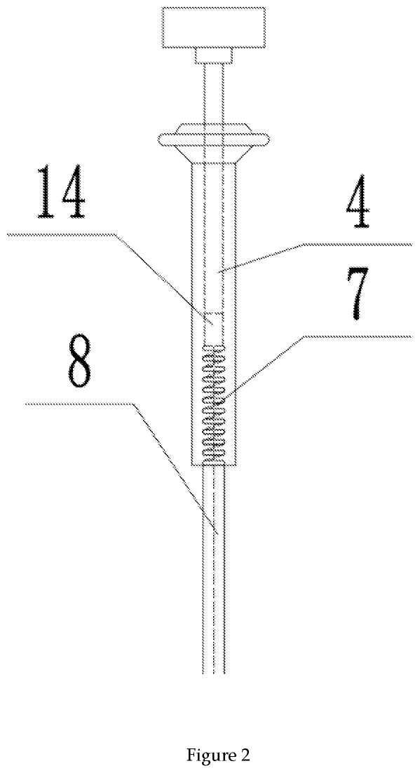

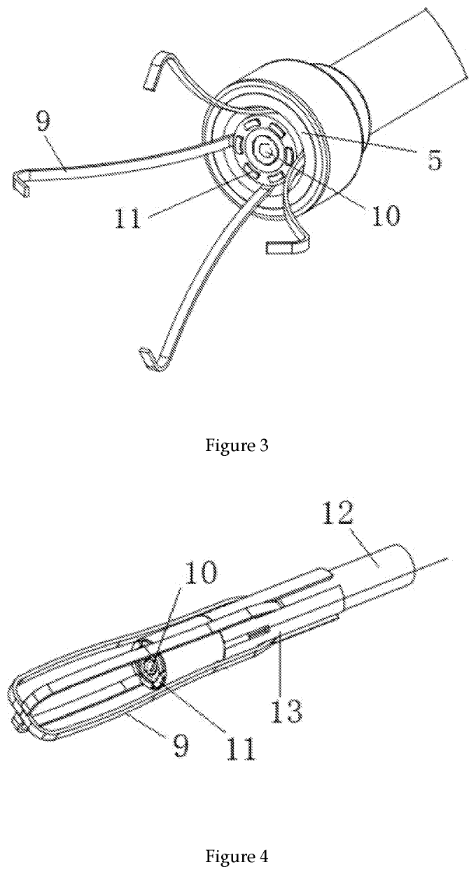

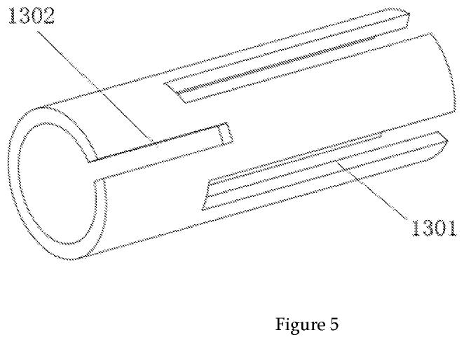

As shown in FIGS. 1-5, this embodiment provides a visual grabber 100, including sequentially connected restraint tube 1, spring tube 2 (preferably a flexible gooseneck tube), and buffer tube 3. Specifically, internal threaded holes are set on the ends of restraint tube 1 and buffer tube 3 close to spring tube 2 according to the spring wire diameter and pitch of spring tube 2, so that the two ends of spring tube 2 are connected with restraint tube 1 and buffer tube 3 with threads. Then these connections are subsequently pressed and fixed together. The present invention also includes a visual grabbing unit and a driving unit.

The visual grabbing unit includes grabber unit 9 and a camera tube 13. Camera 10 is mounted in camera tube 13, which can clearly see the surrounding environment of the target object. Grabber unit 9 includes several claws, and several claw slots 1301 are provided on the side wall of the camera tube 13. Each claw can slide in a claw slot 1301 and get connected, with one end of the claw inside the restraint tube 1 and the other end extending out of the restraint tube 1 to grip the target object. It should be noted that the claws are biased in an open state when prefabricated, and when most of them are closed inside the restraint tube 1, their claw ends far away from the restraint tube 1 will approach each other and hold the target object.

In one embodiment, the driving unit includes a flexible push-pull rod 8, and the claw body 9 is connected to the front end of the flexible push-pull rod 8 through the front connector 12 at one end far away from the camera tube 13. The camera tube 13 is fixed to the front connector 12 at one end close to the front connector 12. Specifically, the rear end of the grabber unit 9 is clamped between the camera tube 13 and the front connector 12. The insertion plates between the two adjacent claw slots 1301 on the camera tube 13 are inserted into the outer wall of the front connector 12. The whole unit is preferably tightened and fixed with adhesive. The rear end of the flexible push-pull rod 8 is connected to the rear connector 14 and the center tube 4. The rear connector 14 is located at one end of the center tube 4 away from pressing box 6. The flexible push-pull rod 8 passes through the restraint tube 1, the spring tube 2, the buffer tube 3, the rear connector 14, and the center tube 4. The buffer tube 3 has a passing-through hole at one end close to the center tube 4. Center tube 4 can pass through the hole. The rear connector 14 and the center tube 4 both slide into to the buffer tube 3 through the hole. The end of the center tube 4 away from the buffer tube 3 is connected to the pressing box 6. The pressing box 6 is equipped with a circuit board, and the camera 10 is electrically connected to the circuit board by wires.

In this embodiment, the material of the claws of the grabber unit 9 are formed from spring steel, although it should be understood that any suitable material may be used. Using the characteristics of spring steel, the prefabricated structure of the grabber unit 9 claws are biased to a fully open state. When the rear end of the grabber unit 9 claws (i.e., the end closest to the constraint tube 1) moves towards the restraint tube 1, the individual claws in the grabber unit 9 approach each other to clamp the target object. When the grabber unit 9 claws are pushed out of the restraint tube 1, the individual claws will return to the open state, making the grabber unit 9 claws open.

In this embodiment, the grabber unit 9 includes four claws, which are fixed on the front connector 12 at one end inside the constraint tube 1. Those skilled in the art can also adjust the specific number of claws according to actual needs, and the number of claws is preferably an even number.

In the manufacturing process, two opposite claws are preferably supported by a spring steel through bending technical process, and a strip spring steel can make a V-shaped claw. A V-shaped claw in this embodiment is two opposing claws that may move between an open and closed position. Since there are four claws in this embodiment, two V-shaped claws are formed in the manufacturing process, and the tips of the two V-shaped claws are preferably joined together, and an extension part is extended in the direction away from the free end of the V-shaped claw.

In this embodiment, the front connector 12 is an aluminum alloy tube. The extension part of grabber unit 9 claws extend into the aluminum alloy tube and are fixed thereto. Specifically, the terminal pressing machine is used to clamp and fix the extension part of the grabber unit 9 (that is, the V-shaped claw) in the aluminum alloy tube, or it can be fixed by welding or other methods.

In this embodiment, a wire groove 1302 is provided on the camera tube 13, and the connecting wire of the camera 10 can pass through the wire groove 1302, which facilitates the arrangement of the connecting wires of the camera 10. The connecting wires of the camera 10 sequentially pass through the center of the constraint tube 1, spring tube 2, buffer tube 3, and center tube 4 and finally connects to the circuit board in the pressing box 6.

In this embodiment, a rear connector 14 is provided at the end of the center tube 4 away from the pressing box 6. The rear connector 14 is a cylindrical structure, with a first channel and a second channel provided thereon. The first channel and the second channel are parallel to each other, with one end of the flexible push-pull rod 8 fixed in the first channel, and the connecting wires of the camera 10 is electrically connected to the circuit board pass through the second channel.

In this embodiment, a reset spring 7 is provided inside the buffer tube 3. One end of the reset spring 7 can abut the rear connector, and the other end of the reset spring 7 can abut one end of the spring tube 2.

It should be noted that the flexible push-pull rod 8 passes through the central channel of the reset spring 7, and a steel wire rope or cable with suitable strength can be used for the flexible push-pull rod 8.

When it is necessary to open the grabber unit 9, simply push the pressing box 6. The pressing box 6 sequentially pushes the rear connector 14, center tube 4, flexible push-pull rod 8, and front connector 12, thereby pushing the grabber unit 9 out to open it and providing a field of view for the camera 10. During this process, the operator's hand is constantly pressing metal box 6. When it is necessary to grip the target object, the operator needs only to release their hand, and under the elastic force of the reset spring 7, the center tube 4 can be reset. In this way, the reset spring 7 biases the push-pull rod 8, as well as the claws of the grabber unit 9 into a retracted position, and pressing the pressing box 6 serves to extend the push-pull rod 8 outwardly, thereby extending and opening the claws of the grabber unit 9 into an open position. As the center tube 4 resets, the connected rear connector, pressing box 6, flexible push-pull rod 8, and front connector 12 will also reset, thereby closing the grabber unit 9. The overall structure is simple, the manufacturing process is straightforward, and the device is easy to operate.

In this embodiment, a USB interface is provided on the pressing box 6. Users can plug a USB data cable into the USB interface, with the other end of the USB data cable connected to the user's mobile phone or computer, conversion box, or any suitable type of video monitor or screen, allowing the real-time transmission of images captured by the camera 10 to the phone or computer, or to any other suitable type of digital display screen. This arrangement facilitates easy adjustment of the position of the grabber body 9.

In this embodiment, LED lights 11 are provided at the front end of the camera 10. The LED lights 11 serve to provide a light source for the camera 10 in a dark environment, making it easier to capture clear images.

In this embodiment, a ring of magnets 5 is preferably provided at the end of the constraint tube 1, away from the spring tube 2. The magnets are used to attract and remove some magnetically susceptible foreign objects, providing a method to lift the target object. The magnetic ring, when combined with the grabber body 9, enhances the grabbing strength on the target object.

In actual use, first connect the USB cable of the visual grabber 100 to the USB interface of a mobile phone or computer. The phone or computer may supply power to the camera 10, and the LED lights 11 around the camera 10 turn on. The images captured by the camera 11 are displayed on the screen of the mobile phone or computer. Push the pressing box 6, and the pressing box 6 pushes the center tube 4 and the flexible push-pull rod 8 to push the front connector 12, grabber unit 9, and camera tube 13 outwards. When the grabber unit 9 is pushed outward from the constraint tube 1, the claws at the end away from the constraint tube 1 separate from each other, causing the grabber unit 9 claws to open, thereby providing a field of view for the camera 10 for shooting videos. The operator can visually guide the visual grabber 100 into the vicinity of the target object to be grabbed. As the spring tube 2 has a certain deformation ability, the overall device can adapt to different working environments. Camera 10 can detect the position of the target object and the surrounding environment, making it easier for the operator to move the grabber unit 9 to the target object. When the grabber unit 9 claws contact the target object, a user releases the pressing box 6 and retracts the flexible push-pull rod 8, which in turn causes the grabber unit 9 claws to close towards the constraint tube 1, driving the individual claws to approach each other and pick up the target object. Finally, withdraw the entire device.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A visual grabber assembly comprising:
an elongated hollow tube having a series of sections, said tube sections comprising a restraint tube, a spring tube and a buffer tube;
a spring loaded push pull rod extending through said elongated tube, said spring loaded push pull rod being attached at a first end to a pressing box, wherein said spring loaded push pull rod is slidably engaged within said elongated hollow tube;
a grabber unit including a plurality of claws slidably engaged within a free end of said restraint tube, said claws being operatively connected to said spring loaded push pull rod so that said claws extend outwardly from said restraint tube and into an open position when said pressing box is depressed;
a camera tube disposed between said claws, and a camera attached to said camera tube; and
said camera adapted to be operatively connected to a video screen.

2. The visual grabber assembly set forth in claim 1, wherein said camera tube further includes a light attached thereto.

3. The visual grabber assembly set forth in claim 1, wherein said camera tube includes a plurality of claw grooves for slidably engaging said claws.

4. The visual grabber assembly set forth in claim 1, wherein said camera is operatively connected to a circuit board.

5. The visual grabber assembly set forth in claim 1, wherein a USB interface is operatively connected to said camera.

6. The visual grabber assembly set forth in claim 5, wherein said USB interface is positioned on said pressing box.

7. The visual grabber assembly set forth in claim 1, further including a magnet attached to said restraint tube.
